(19) United States
(12) Patent Application Publication
(10) Pub. No.: US 2025/0284416 A1
(43) Pub. Date: Sep. 11, 2025

(54) DYNAMIC RECONFIGURATION OF PROTOCOL LAYER PARAMETERS

(71) Applicant: Micron Technology, Inc., Boise, ID (US)

(72) Inventors: Youshou Chen, Shanghai (CN); De Hua Guo, Shanghai (CN)

(21) Appl. No.: 19/052,094

(22) Filed: Feb. 12, 2025

Related U.S. Application Data
(60) Provisional application No. 63/561,658, filed on Mar. 5, 2024.

(51) Int. Cl. G06F 3/06

(52) U.S. Cl. CPC G06F 3/0629; G06F 3/0625; G06F 3/0655; G06F 3/0679

(57) ABSTRACT

Methods, systems, and devices for dynamic reconfiguration of protocol layer parameters are described. As an example of the methods, a memory system may establish, while the memory system operates according to a first power state, a communications link between the memory system and a host system that is based on one or more first parameters associated with a first protocol layer. Further, the memory system may determine whether a temperature metric of the memory system satisfies a threshold based on a power state of the memory system changing from the first power state to a second power state and communicate, while operating according to the second power state, data from the memory system using the communications link that is based on one or more second parameters associated with the first protocol layer.

### CROSS REFERENCE

The present Application for Patent claims priority to U.S. Patent Application No. 63/561,658 by Chen et al., entitled “DYNAMIC RECONFIGURATION OF PROTOCOL LAYER PARAMETERS,” filed Mar. 5, 2024, which is assigned to the assignee hereof, and which is expressly incorporated by reference in its entirety herein.

### TECHNICAL FIELD

The following relates to one or more systems for memory, including dynamic reconfiguration of protocol layer parameters.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports dynamic reconfiguration of protocol layer parameters in accordance with examples as disclosed herein.

FIG. 2 shows an example of a system that supports dynamic reconfiguration of protocol layer parameters in accordance with examples as disclosed herein.

FIG. 3 shows an example of a flow diagram that supports dynamic reconfiguration of protocol layer parameters in accordance with examples as disclosed herein.

FIG. 4 shows a block diagram of a memory system that supports dynamic reconfiguration of protocol layer parameters in accordance with examples as disclosed herein.

FIGS. 5 and 6 show flowcharts illustrating a method or methods that support dynamic reconfiguration of protocol layer parameters in accordance with examples as disclosed herein.

### DETAILED DESCRIPTION

At initialization of a memory system, firmware of the memory system may configure one or more physical layer parameters. The physical layer parameters may include parameters that the memory system may utilize while communicating with a host system over a physical medium such as a communication line. An example of a physical layer parameter may include a resistor termination scheme. In some examples, the firmware may configure the physical layer parameters once and the memory system may utilize the configured physical layer parameters throughout operation of the memory system. However, in some examples, an operating temperature of the memory system may change during operation. One or more aspects of the memory system may be temperature dependent and may change in response to the change in operating temperature. Therefore, if the memory system experiences different operating temperatures, the initial configuration of the one or more physical layer parameters may no longer be applicable or appropriately configured for the memory system.

As described herein, the memory system may be able to reconfigure physical layer parameters based on or in response to a change in one or more temperature metrics of the memory system. In some examples, the firmware may configure the memory system with one or more first physical layer parameters and monitor one or more temperature metrics of the memory system. If the firmware determines that the one or more temperature metrics of the memory system satisfies a threshold, the firmware may update at least some of one or more physical layers parameters from the one or more first physical layer parameters to one or more second physical layer parameters. In some examples, the firmware may update the one or more physical layer parameters during a safe point, which may include a period of time in which the memory system transitions to a disabled state, a hibernate state, or a sleep state, among various other examples. Using these methods, the memory system may dynamically adjust physical layer parameters (or improve signal quality) for varying temperature conditions of the memory system.

In addition to applicability in memory systems as described herein, techniques for dynamic reconfiguration of protocol layer parameters may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by optimizing parameters associated with a physical layer of the memory system, which may decrease latency, improve response times, or otherwise improve user experience, among other benefits.

Features of the disclosure are illustrated and described in the context of systems, devices, and circuits. Features of the disclosure are further illustrated and described in the context of flow diagrams and flowcharts.

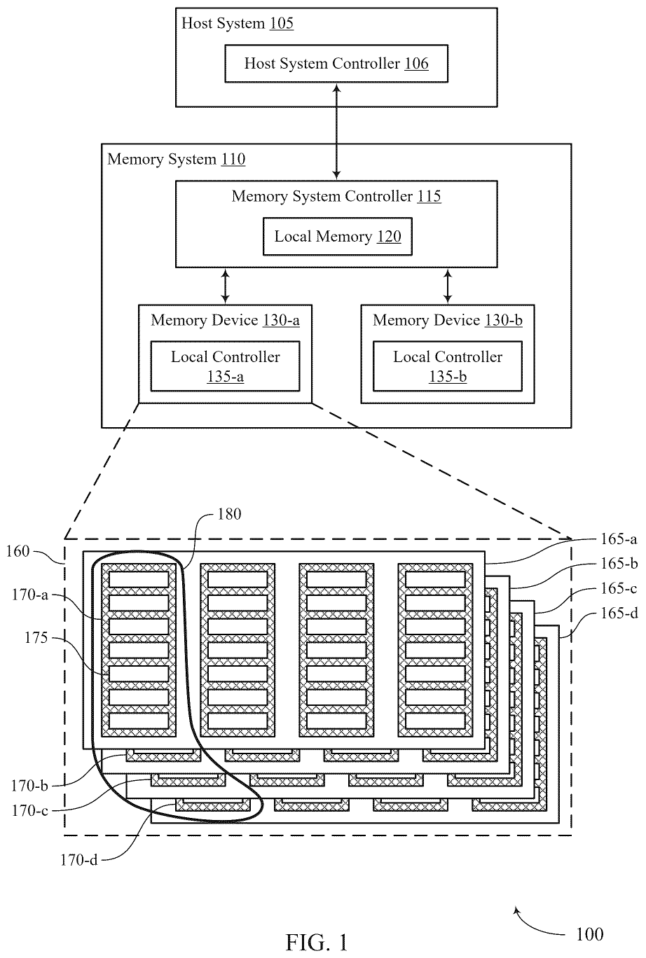

FIG. 1 shows an example of a system 100 that supports dynamic reconfiguration of protocol layer parameters in accordance with examples as disclosed herein. The system 100 includes a host system 105 coupled with a memory system 110. The system 100 may be included in a computing device such as a desktop computer, a laptop computer, a network server, a mobile device, a vehicle (e.g., automobile, train, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support dynamic reconfiguration of protocol layer parameters. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

As described herein, the memory system 110 (e.g., the memory system controller 115) may dynamically reconfigure protocol layer parameters of the memory system 110. In some examples, the memory system 110 may establish, while operating according to a first power state, a communications link with the host system 105. Further, the memory system 110 may communicate first data with the host system 105 via the communications link in accordance to one or more first parameters associated with a first protocol layer (e.g., a physical layer) of the memory system 110.

Moreover, the memory system 110 may monitor a temperature metric of the memory system 110 and determine whether the temperature metric satisfies a threshold in response to the memory system 110 changing from a first power state to a second power state. If the temperature metric satisfies the threshold (e.g., above or below the threshold), the memory system 110 may update one or more parameters associated with the first protocol layer from the one or more first parameters to one or more second parameters different than the one or more second first parameters. Upon updating the one or more parameters, the memory system 110 may communicate data with the host system 105 via the communications link in accordance to the one or more second parameters. Using the methods as described herein may allow the memory system 110 to optimize communication with a host system 105 when the memory system 110 experiences changes in operating temperature.

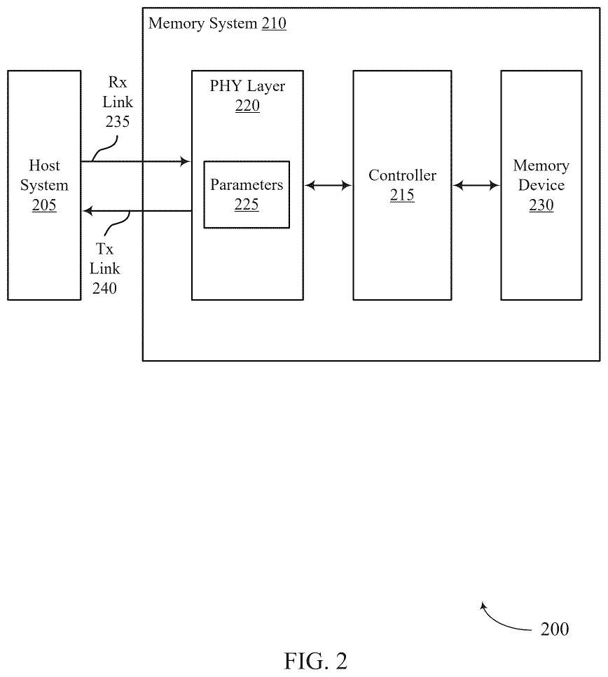

FIG. 2 shows an example of a system 200 that supports dynamic reconfiguration of protocol layer parameters in accordance with examples as disclosed herein. In some examples, the system 200 may implement aspects of a system 100. For example, the system 200 may include a host system 205, a memory system 210, a controller 215, and a memory device 230 which may be examples of a host system 105, a memory system 110, a memory system controller 115, and a memory device 130 as described with reference to FIG. 1, respectively.

In some examples, the memory system 210 may communicate with a host system 205. In order to communicate with the host system 205, the memory system 210 may establish a communications link. The communications link may a reception (Rx) link 235 over which the memory system 210 may receive signaling from the host system 205 and a transmission (Tx) link 240 over which the memory system 210 may transmit signaling to the host system 205. In some examples, the memory system 210 may operate in accordance to a protocol stack. The protocol stack at the memory system 210 may include different layers and each layer may serve a different function. When the memory system 210 communicates (e.g., transmits or receives) data to the host system 205 via the communications link, the data may pass through the layers of the protocol stack of the memory system 210.

In some examples, the bottom-most layer of the protocol stack may include the physical layer 220. The physical layer 220 may be associated with physical connections between the host system 205 and the memory system 210. Further, the physical layer 220 may define parameters 225 of physical signal transmission over a transmission line (e.g., the communications link) and provide an interface to the transmission line. Some examples of parameters 225 defined by the physical layer 220 may include a resistor termination scheme for a receiver module (M-RX) or a transmitter module (M-RX) of the physical layer 220, values associated with a voltage controlled oscillator (VCO) of the memory system 210, properties of electrical connectors, transmission speeds (e.g., a bit rate), clock modes, etc.

Further, the physical layer 220 may support different modes of operation. The modes of operation may include an unpowered mode, a disabled mode, a hibernate mode, a low speed (LS) mode, and a high speed (HS) mode. The LS mode may define a sleep mode as well as a pulse width modulation (PWM)-burst state for the physical layer 220. The HS mode, on the other hand, may define a stall mode as well as a HS-burst state for the physical layer 220. The disabled mode may be the lowest power mode. When a power supply for the memory system 210 is turned on, the physical layer 220 may initially enter the disabled mode. From the disabled mode, the physical layer 220 may transition to the hibernate mode which may defined as an ultra-low power state. After entering the hibernate mode, the physical layer 220 may transition between the stall mode, the sleep mode, and potentially, back to the hibernate mode.

In some examples, a temperature of the memory system 210 may change during operation of the memory system 210. For example, during operation, the temperature of the memory system 210 may increase from a first temperature to a second temperature. Many aspects of the memory system 210 may be temperature dependent. As such, the parameters 225, as initially configured at the physical layer 220, may no longer be applicable if the memory system 210 experiences a temperature change. Currently, there is no method in place to reconfigure the physical layer 220. As such, if the memory system 210 experiences a temperature change, the parameters 225 may no longer be applicable (e.g., output the expected results).

As described herein, the memory system 210 may support temperature dependent reconfiguration of the physical layer 220. In some examples, the physical layer 220 of the memory system 210 may enter a first state of operation and support one or more first parameters 225. While the physical layer 220 is in the first state of operation, the memory system 210 may monitor a temperature metric of the memory system 210. In some examples, the temperature metric may refer to an operating temperature of the memory system 210. The memory system 210 (e.g., the controller 215) may monitor the temperature metric by periodically or aperiodically polling a mode register of the memory system 210 that is configured to store temperature information for the memory system 210.

If the memory system 210 identifies a change in the temperature metric, the memory system 210 may compare aspects of the temperature metric to a threshold. As one example, the memory system 210 may identify that an operating temperature of the memory system 210 has changed from a first operating temperature to a second operating temperature. In such example, the memory system 210 may compare the second operating temperature of the memory system 210 to a first threshold. If the second operating temperature satisfies the first threshold (e.g., is equal to, above, or below the first threshold), the memory system 210 may reconfigure the physical layer 220. For example, the first threshold may be 65 degrees Celsius. In such example, if the first operating temperature is below 65 degrees Celsius and the second operating temperature is equal to or above 65 degree Celsius, the memory system 210 may reconfigure the physical layer 220.

Additionally or alternatively, the memory system 210 may compare a difference between the first operating temperature and the second operating temperature to a second threshold. If the difference satisfies (e.g., is equal to, above, or below) the second threshold, the memory system 210 may reconfigure the physical layer 220. For example, the second threshold may be 25 degrees Celsius. In such example, if the difference (e.g., absolute difference) between first operating temperature and the second operating temperature is greater than or equal to 25 degrees Celsius, the memory system 210 may reconfigure the physical layer 220. If aspects of the temperature metric fail to satisfy the first threshold or the second threshold, the memory system 210 may not reconfigure the physical layer 220 and the first parameters 225 may be maintained for the physical layer 220.

In some examples, reconfiguring the physical layer 220 may include updating the parameters 225 from the first parameters 225 to second parameters 225 that are different from the first parameters 225. As an example, in response to detecting a change in the temperature metric, the memory system 210 may update a resistor termination scheme for the physical layer 220. For example, the memory system 210 may enable or disable resistor termination at the M-TX or the M-RX of the physical layer 220, increase or decrease a termination resistance at the M-TX or the M-RX of the physical layer 220, etc. Additionally or alternatively, in response to a change in the temperature metric, the memory system 210 may update a range of values associated with a VCO of the physical layer 220. For example, the memory system 210 may change a range of control voltages for the VCO.

In some examples, the memory system 210 (e.g., memory device 230) may store a set of values (or range of values) that correspond to the parameters 225. In some examples, each value in the set of values may correspond to a temperature value or a range of temperature values. For example, a first value of the set of values may correspond to a temperature greater than or equal to the first threshold (e.g., greater than or equal to 65 degrees Celsius) and a second value of the set of values may correspond to a temperature less than the first threshold (e.g., less than 65 degrees Celsius). If the temperature metric exceeds the first threshold, the memory system 210 may read the first value from the set of values and reconfigure the physical layer 220 by setting a value of the parameters 225 to the first value (or updating the first parameters to the second parameters). Additionally or alternatively, the memory system 210 may input the temperature metric (e.g., the second operating temperature) into an algorithm and set the value of the parameter 225 to an output value of the algorithm.

In some examples, the memory system 210 may reconfigure the physical layer 220 during a safe point. A safe point may refer to time in which the memory system 210 transitions from the first mode of operation to a second mode of operation. For example, the safe point may include a period in time that that the physical layer 220 transitions from the first mode of operation to the disable mode, the hibernate mode, or the sleep mode. If the memory system 210 senses the change in the temperature metric prior to the switch in operating mode, the memory system 210 may wait to reconfigure the physical layer 220 until the switch in operating mode occurs.

Upon reconfiguring the physical layer 220, the memory system 210 may communicate with the host system 205 according to the second parameters 225. Using the methods as described herein, a memory system 210 may mitigate the negative of effects of temperature on physical layer parameters which may optimize communication between the memory system 210 and the host system 205.

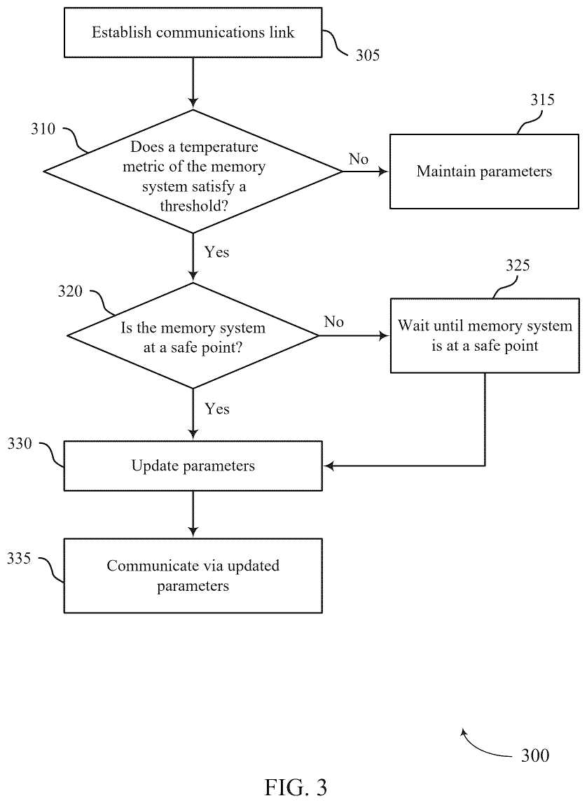

FIG. 3 shows an example of a flow diagram 300 that supports dynamic reconfiguration of protocol layer parameters in accordance with examples as disclosed herein. In some examples, the flow diagram 300 may be implemented by aspects of a system 100 and a system 200. For example, the flow diagram 300 may be implemented by a memory system 110 and a memory system 210 as described with reference to FIGS. 1 and 2, respectively.

At 305, a communications link is established. For example, a memory system may establish a communications link with a host system and communicate with the host system while the memory system operates according to a first power state. In some examples, the first power state may include a disable state, a hibernate state, a sleep state, a stall state, or an unpowered state. Further, the communications link may be associated with one or more first parameters associated with a first protocol layer of the memory system. The first protocol layer may include a physical layer of a protocol stack associated with the memory system.

At 310, it may be determined whether a temperature metric of the memory system satisfies a threshold. For example, the memory system may determine whether the temperature metric of the memory system satisfies the threshold. In some examples, the temperature metric may satisfy the threshold if the temperature metric is above the threshold, meets the threshold, or is below the threshold.

In some examples, prior to determining whether the temperature metric satisfies the threshold, the memory system may determine whether the temperature metric has changed. For example, the memory system may determine a first operating temperature of the memory system at a first time, determine a second operating temperature of the memory system at a second time that occurs after the first time, and compare the first operating temperature to the second operating temperature. If the first operating temperature is different from the second operating temperature, the memory system may then determine if the second temperature metric satisfies the threshold at 310.

Additionally or alternatively, the memory system may determine whether a difference between a previous temperature metric and the current temperature metric satisfies a second threshold. For example, the memory system may determine a difference between the first operating temperature and the second operating temperature and compare the difference to the second threshold to determine whether the difference satisfies the second threshold.

If the memory system determines that the temperature metric does not satisfy the threshold, the second threshold, or both, the memory system may proceed to 315. Alternatively, if the memory system determines that the temperature metric does satisfy the threshold, the second threshold, or both, the memory system may proceed to 320.

At 315, the one or more first parameters may be maintained. For example, the memory system may maintain the one or more first parameters. That is, the value of the one or more first parameters (e.g., PHY layer parameters) may not be altered by the memory system if the temperature metric is determined to not satisfy the threshold, the second threshold, or both.

At 320, it is determined whether the memory system is at a safe point. For example, the memory system may determine if the memory is at a safe point. The memory system may determine that is at the safe point if the memory system is changing from the first power state to a second power state. For example, if the memory system is changing from the first power state to the disabled state, the hibernate state, or the sleep state, the memory system may determine that the memory system is at a safe point. If the memory system is not changing from the first power state to the disabled state, the hibernate state, or the sleep state, the memory system may determine that the memory is not at a safe point. If the memory system is at a safe point, the memory system may proceed to 330. Alternatively, if the memory system is not at a safe point, the memory system may proceed to 325.

At 325, a safe point is determined by the memory system. For example, the memory system may wait for the memory system to experience the safe point. If the memory system experiences a safe point, the memory system may proceed to 330.

At 330, one or more parameters associated with the first protocol layer may be updated from the one or more first parameters to the one or more second parameters. For example, the memory system may update the one or more parameters (e.g., PHY layer parameters) from the one or more first parameters to the one or more second parameters. In some examples, updating the one or more parameters may include adjusting a resistor termination scheme associated with the first protocol layer. Additionally or alternatively, updating the one or more parameters may include adjusting a range of values corresponding to a VCO associated with the first protocol layer. Upon updating the one or more parameters, the memory system may proceed to 335.

At 335, signaling may be communicated between the host system and the memory system. For example, the memory system may communication with the host system via the communications link according to the one or more second parameters. Using the process as described herein may allow the memory system to optimize physical layer parameters during varying temperature conditions.

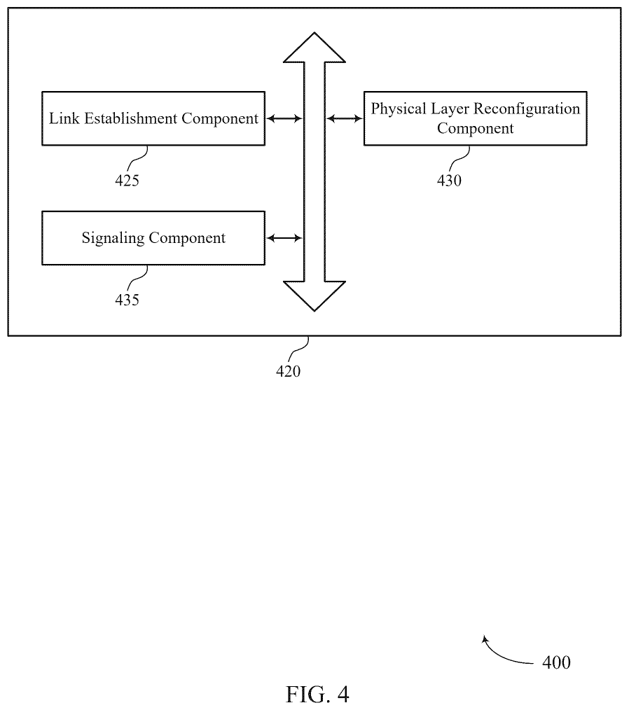

FIG. 4 shows a block diagram 400 of a memory system 420 that supports dynamic reconfiguration of protocol layer parameters in accordance with examples as disclosed herein. The memory system 420 may be an example of aspects of a memory system as described with reference to FIGS. 1 through 3. The memory system 420, or various components thereof, may be an example of means for performing various aspects of dynamic reconfiguration of protocol layer parameters as described herein. For example, the memory system 420 may include a link establishment component 425, a physical layer reconfiguration component 430, a signaling component 435, or any combination thereof. Each of these components, or components of subcomponents thereof (e.g., one or more processors, one or more memories), may communicate, directly or indirectly, with one another (e.g., via one or more buses).

The link establishment component 425 may be configured as or otherwise support a means for establishing, while the memory system operates according to a first power state, a communications link between the memory system and a host system, the communications link based at least in part on one or more first parameters associated with a first protocol layer. The physical layer reconfiguration component 430 may be configured as or otherwise support a means for determining whether a temperature metric of the memory system satisfies a threshold based on a power state of the memory system changing from the first power state to a second power state. The signaling component 435 may be configured as or otherwise support a means for communicating, while operating according to the second power state and based at least in part on the temperature metric satisfying the threshold, data from the memory system using the communications link based at least in part on one or more second parameters associated with the first protocol layer, where the one or more second parameters are different from the one or more first parameters.

In some examples, the first power state includes a disable state, a hibernate state, a sleep state, a stall state, or an unpowered state and the second power state is different from the first power state and includes the disable state, the hibernate state, or the sleep state.

In some examples, the physical layer reconfiguration component 430 may be configured as or otherwise support a means for updating one or more parameters associated with the first protocol layer from the one or more first parameters to the one or more second parameters based at least in part on determining that the temperature metric satisfies the threshold.

In some examples, to support updating the one or more parameters from the one or more first parameters to the one or more second parameters, the physical layer reconfiguration component 430 may be configured as or otherwise support a means for adjusting a resistor termination scheme associated with the first protocol layer.

In some examples, to support updating the one or more parameters from the one or more first parameters to the one or more second parameters, the physical layer reconfiguration component 430 may be configured as or otherwise support a means for adjusting a range of values corresponding to a VCO associated with the first protocol layer.

In some examples, to support determining whether the temperature metric satisfies the threshold, the physical layer reconfiguration component 430 may be configured as or otherwise support a means for determining whether the temperature metric is above the threshold. In some examples, to support determining whether the temperature metric satisfies the threshold, the physical layer reconfiguration component 430 may be configured as or otherwise support a means for determining whether the temperature metric meets the threshold. In some examples, to support determining whether the temperature metric satisfies the threshold, the physical layer reconfiguration component 430 may be configured as or otherwise support a means for determining whether the temperature metric is below the threshold.

In some examples, the physical layer reconfiguration component 430 may be configured as or otherwise support a means for determining, at a first time, a first operating temperature of the memory system, where the temperature metric includes the first operating temperature. In some examples, the physical layer reconfiguration component 430 may be configured as or otherwise support a means for determining, at a second time that is prior to the first time, a second operating temperature of the memory system, where a second temperature metric includes the second operating temperature. In some examples, the physical layer reconfiguration component 430 may be configured as or otherwise support a means for comparing the temperature metric to the second temperature metric based at least in part on determining the temperature metric. In some examples, determining whether a difference between the temperature metric and the second temperature metric satisfies the threshold.

In some examples, the physical layer reconfiguration component 430 may be configured as or otherwise support a means for determining that the second temperature metric is different from the temperature metric, where determining whether the temperature metric satisfies the threshold is based at least in part on determining that the second temperature metric is different from the temperature metric. In some examples, the first protocol layer includes a physical layer.

In some examples, the signaling component 435 may be configured as or otherwise support a means for communicating, while operating according to the first power state and based at least in part on establishing the communications link, second data from the memory system using the communications link based at least in part on one or more first parameters associated with the first protocol layer.

In some examples, the link establishment component 425 may be configured as or otherwise support a means for establishing, while the memory system operates according to a first power state, a communications link between the memory system and a host system, the communications link based at least in part on a first resistor termination scheme associated with a first protocol layer. In some examples, the physical layer reconfiguration component 430 may be configured as or otherwise support a means for determining whether a temperature metric of the memory system satisfies a threshold based on a power state of the memory system changing from the first power state to a second power state. In some examples, the signaling component 435 may be configured as or otherwise support a means for communicating, while operating according to the second power state and based at least in part on the temperature metric satisfying the threshold, data from the memory system using the communications link based at least in part on a second resistor termination scheme associated with the first protocol layer, where the first resistor termination scheme is different than the second resistor termination scheme.

In some examples, the first power state includes a disable state, a hibernate state, a sleep state, a stall state, or an unpowered state and the second power state is different from the first power state and includes the disable state, the hibernate state, or the sleep state.

In some examples, the physical layer reconfiguration component 430 may be configured as or otherwise support a means for updating a resistor termination scheme associated with the first protocol layer from the first resistor termination scheme to the second resistor termination scheme based at least in part on determining that the temperature metric satisfies the threshold.

In some examples, to support determining whether the temperature metric satisfies the threshold, the physical layer reconfiguration component 430 may be configured as or otherwise support a means for determining whether the temperature metric is above the threshold. In some examples, to support determining whether the temperature metric satisfies the threshold, the physical layer reconfiguration component 430 may be configured as or otherwise support a means for determining whether the temperature metric meets the threshold. In some examples, to support determining whether the temperature metric satisfies the threshold, the physical layer reconfiguration component 430 may be configured as or otherwise support a means for determining whether the temperature metric is below the threshold.

In some examples, the physical layer reconfiguration component 430 may be configured as or otherwise support a means for determining, at a first time, a first operating temperature of the memory system, where the temperature metric includes the first operating temperature. In some examples, the physical layer reconfiguration component 430 may be configured as or otherwise support a means for determining, at a second time that is prior to the first time, a second operating temperature of the memory system, where a second temperature metric includes the second operating temperature. In some examples, the physical layer reconfiguration component 430 may be configured as or otherwise support a means for comparing the temperature metric to the second temperature metric based at least in part on determining the temperature metric. In some examples, determining whether a difference between the temperature metric and the second temperature metric satisfies the threshold.

In some examples, the physical layer reconfiguration component 430 may be configured as or otherwise support a means for determining that the second temperature metric is different from the temperature metric, where determining whether the temperature metric satisfies the threshold is based at least in part on determining that the second temperature metric is different from the temperature metric. In some examples, the first protocol layer includes a physical layer.

In some examples, the signaling component 435 may be configured as or otherwise support a means for communicating, while operating according to the first power state and based at least in part on establishing the communications link, second data from the memory system using the communications link based at least in part on the first resistor termination scheme associated with the first protocol layer.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

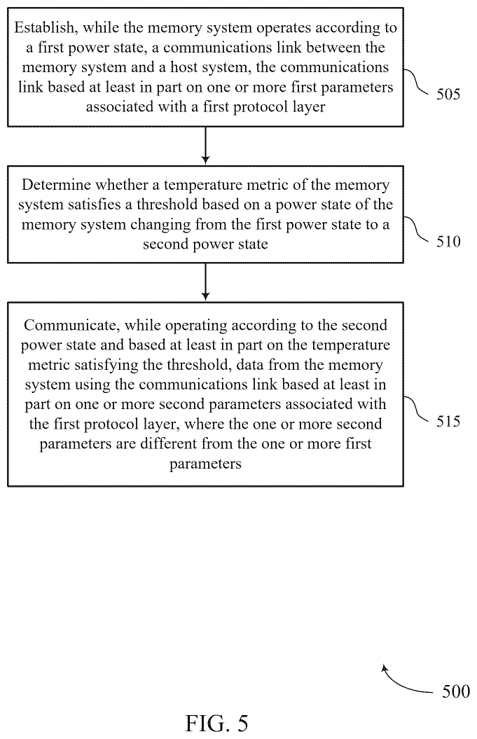

FIG. 5 shows a flowchart illustrating a method 500 that supports dynamic reconfiguration of protocol layer parameters in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include establishing, while the memory system operates according to a first power state, a communications link between the memory system and a host system, the communications link based at least in part on one or more first parameters associated with a first protocol layer. In some examples, aspects of the operations of 505 may be performed by a link establishment component 425 as described with reference to FIG. 4.

At 510, the method may include determining whether a temperature metric of the memory system satisfies a threshold based on a power state of the memory system changing from the first power state to a second power state. In some examples, aspects of the operations of 510 may be performed by a physical layer reconfiguration component 430 as described with reference to FIG. 4.

At 515, the method may include communicating, while operating according to the second power state and based at least in part on the temperature metric satisfying the threshold, data from the memory system using the communications link based at least in part on one or more second parameters associated with the first protocol layer, where the one or more second parameters are different from the one or more first parameters. In some examples, aspects of the operations of 515 may be performed by a signaling component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for establishing, while the memory system operates according to a first power state, a communications link between the memory system and a host system, the communications link based at least in part on one or more first parameters associated with a first protocol layer; determining whether a temperature metric of the memory system satisfies a threshold based on a power state of the memory system changing from the first power state to a second power state; and communicating, while operating according to the second power state and based at least in part on the temperature metric satisfying the threshold, data from the memory system using the communications link based at least in part on one or more second parameters associated with the first protocol layer, where the one or more second parameters are different from the one or more first parameters.

Aspect 2: The method, apparatus, or non-transitory computer-readable medium of aspect 1, where the first power state includes a disable state, a hibernate state, a sleep state, a stall state, or an unpowered state and the second power state is different from the first power state and includes the disable state, the hibernate state, or the sleep state.

Aspect 3: The method, apparatus, or non-transitory computer-readable medium of any of aspects 1 through 2, further including operations, features, circuitry, logic, means, or instructions, or any combination thereof for updating one or more parameters associated with the first protocol layer from the one or more first parameters to the one or more second parameters based at least in part on determining that the temperature metric satisfies the threshold.

Aspect 4: The method, apparatus, or non-transitory computer-readable medium of aspect 3, where updating the one or more parameters from the one or more first parameters to the one or more second parameters includes operations, features, circuitry, logic, means, or instructions, or any combination thereof for adjusting a resistor termination scheme associated with the first protocol layer.

Aspect 5: The method, apparatus, or non-transitory computer-readable medium of any of aspects 3 through 4, where updating the one or more parameters from the one or more first parameters to the one or more second parameters includes operations, features, circuitry, logic, means, or instructions, or any combination thereof for adjusting a range of values corresponding to a VCO associated with the first protocol layer.

Aspect 6: The method, apparatus, or non-transitory computer-readable medium of any of aspects 1 through 5, where determining whether the temperature metric satisfies the threshold includes operations, features, circuitry, logic, means, or instructions, or any combination thereof for determining whether the temperature metric is above the threshold; determining whether the temperature metric meets the threshold; and determining whether the temperature metric is below the threshold.

Aspect 7: The method, apparatus, or non-transitory computer-readable medium of any of aspects 1 through 6, further including operations, features, circuitry, logic, means, or instructions, or any combination thereof for determining, at a first time, a first operating temperature of the memory system, where the temperature metric includes the first operating temperature; determining, at a second time that is prior to the first time, a second operating temperature of the memory system, where a second temperature metric includes the second operating temperature; and comparing the temperature metric to the second temperature metric based at least in part on determining the temperature metric.

Aspect 8: The method, apparatus, or non-transitory computer-readable medium of aspect 7, where determining whether a difference between the temperature metric and the second temperature metric satisfies the threshold.

Aspect 9: The method, apparatus, or non-transitory computer-readable medium of any of aspects 7 through 8, further including operations, features, circuitry, logic, means, or instructions, or any combination thereof for determining that the second temperature metric is different from the temperature metric, where determining whether the temperature metric satisfies the threshold is based at least in part on determining that the second temperature metric is different from the temperature metric.

Aspect 10: The method, apparatus, or non-transitory computer-readable medium of any of aspects 1 through 9, where the first protocol layer includes a physical layer.

Aspect 11: The method, apparatus, or non-transitory computer-readable medium of any of aspects 1 through 10, further including operations, features, circuitry, logic, means, or instructions, or any combination thereof for communicating, while operating according to the first power state and based at least in part on establishing the communications link, second data from the memory system using the communications link based at least in part on one or more first parameters associated with the first protocol layer.

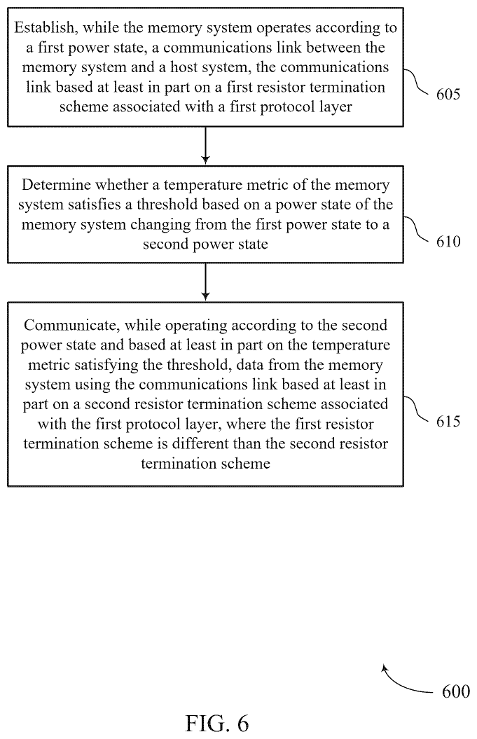

FIG. 6 shows a flowchart illustrating a method 600 that supports dynamic reconfiguration of protocol layer parameters in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include establishing, while the memory system operates according to a first power state, a communications link between the memory system and a host system, the communications link based at least in part on a first resistor termination scheme associated with a first protocol layer. In some examples, aspects of the operations of 605 may be performed by a link establishment component 425 as described with reference to FIG. 4.

At 610, the method may include determining whether a temperature metric of the memory system satisfies a threshold based on a power state of the memory system changing from the first power state to a second power state. In some examples, aspects of the operations of 610 may be performed by a physical layer reconfiguration component 430 as described with reference to FIG. 4.

At 615, the method may include communicating, while operating according to the second power state and based at least in part on the temperature metric satisfying the threshold, data from the memory system using the communications link based at least in part on a second resistor termination scheme associated with the first protocol layer, where the first resistor termination scheme is different than the second resistor termination scheme. In some examples, aspects of the operations of 615 may be performed by a signaling component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for establishing, while the memory system operates according to a first power state, a communications link between the memory system and a host system, the communications link based at least in part on a first resistor termination scheme associated with a first protocol layer; determining whether a temperature metric of the memory system satisfies a threshold based on a power state of the memory system changing from the first power state to a second power state; and communicating, while operating according to the second power state and based at least in part on the temperature metric satisfying the threshold, data from the memory system using the communications link based at least in part on a second resistor termination scheme associated with the first protocol layer, where the first resistor termination scheme is different than the second resistor termination scheme.

Aspect 13: The method, apparatus, or non-transitory computer-readable medium of aspect 12, where the first power state includes a disable state, a hibernate state, a sleep state, a stall state, or an unpowered state and the second power state is different from the first power state and includes the disable state, the hibernate state, or the sleep state.

Aspect 14: The method, apparatus, or non-transitory computer-readable medium of any of aspects 12 through 13, further including operations, features, circuitry, logic, means, or instructions, or any combination thereof for updating a resistor termination scheme associated with the first protocol layer from the first resistor termination scheme to the second resistor termination scheme based at least in part on determining that the temperature metric satisfies the threshold.

Aspect 15: The method, apparatus, or non-transitory computer-readable medium of any of aspects 12 through 14, where determining whether the temperature metric satisfies the threshold includes operations, features, circuitry, logic, means, or instructions, or any combination thereof for determining whether the temperature metric is above the threshold; determining whether the temperature metric meets the threshold; and determining whether the temperature metric is below the threshold.

Aspect 16: The method, apparatus, or non-transitory computer-readable medium of any of aspects 12 through 15, further including operations, features, circuitry, logic, means, or instructions, or any combination thereof for determining, at a first time, a first operating temperature of the memory system, where the temperature metric includes the first operating temperature; determining, at a second time that is prior to the first time, a second operating temperature of the memory system, where a second temperature metric includes the second operating temperature; and comparing the temperature metric to the second temperature metric based at least in part on determining the temperature metric.

Aspect 17: The method, apparatus, or non-transitory computer-readable medium of aspect 16, where determining whether a difference between the temperature metric and the second temperature metric satisfies the threshold.

Aspect 18: The method, apparatus, or non-transitory computer-readable medium of any of aspects 16 through 17, further including operations, features, circuitry, logic, means, or instructions, or any combination thereof for determining that the second temperature metric is different from the temperature metric, where determining whether the temperature metric satisfies the threshold is based at least in part on determining that the second temperature metric is different from the temperature metric.

Aspect 19: The method, apparatus, or non-transitory computer-readable medium of any of aspects 12 through 18, where the first protocol layer includes a physical layer.

Aspect 20: The method, apparatus, or non-transitory computer-readable medium of any of aspects 12 through 19, further including operations, features, circuitry, logic, means, or instructions, or any combination thereof for communicating, while operating according to the first power state and based at least in part on establishing the communications link, second data from the memory system using the communications link based at least in part on the first resistor termination scheme associated with the first protocol layer.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 21: A memory system, including: a controller configured to cause the memory system to: establish, while the memory system operates according to a first power state, a communications link between the memory system and a host system, the communications link based at least in part on one or more first parameters associated with a first protocol layer; determine whether a temperature metric of the memory system satisfies a threshold based on a power state of the memory system changing from the first power state to a second power state; and communicate, while operating according to the second power state and based at least in part on the temperature metric satisfying the threshold, data from the memory system using the communications link based at least in part on one or more second parameters associated with the first protocol layer, where the one or more second parameters are different from the one or more first parameters.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
establish, while the memory system operates according to a first power state, a communications link between the memory system and a host system, the communications link based at least in part on one or more first parameters associated with a first protocol layer;
determine whether a temperature metric of the memory system satisfies a threshold based on a power state of the memory system changing from the first power state to a second power state; and
communicate, while operating according to the second power state and based at least in part on the temperature metric satisfying the threshold, data from the memory system using the communications link based at least in part on one or more second parameters associated with the first protocol layer, wherein the one or more second parameters are different from the one or more first parameters.

2. The memory system of claim 1, wherein the first power state comprises a disable state, a hibernate state, a sleep state, a stall state, or an unpowered state and the second power state is different from the first power state and comprises the disable state, the hibernate state, or the sleep state.

3. The memory system of claim 1, wherein the processing circuitry is further configured to cause the memory system to:
update one or more parameters associated with the first protocol layer from the one or more first parameters to the one or more second parameters based at least in part on determining that the temperature metric satisfies the threshold.

4. The memory system of claim 3, wherein updating the one or more parameters from the one or more first parameters to the one or more second parameters comprises the processing circuitry configured to cause the memory system to:
adjust a resistor termination scheme associated with the first protocol layer.

5. The memory system of claim 3, wherein updating the one or more parameters from the one or more first parameters to the one or more second parameters comprises the processing circuitry configured to cause the memory system to:
adjust a range of values corresponding to a voltage controlled oscillator associated with the first protocol layer.

6. The memory system of claim 1, wherein determining whether the temperature metric satisfies the threshold comprises the processing circuitry configured to cause the memory system to:
determine whether the temperature metric is above the threshold;
determine whether the temperature metric meets the threshold; or
determine whether the temperature metric is below the threshold.

7. The memory system of claim 1, wherein the processing circuitry is further configured to cause the memory system to:
determine, at a first time, a first operating temperature of the memory system, wherein the temperature metric comprises the first operating temperature;
determine, at a second time that is prior to the first time, a second operating temperature of the memory system, wherein a second temperature metric comprises the second operating temperature; and
compare the temperature metric to the second temperature metric based at least in part on determining the temperature metric.

8. The memory system of claim 7, wherein determining whether a difference between the temperature metric and the second temperature metric satisfies the threshold.

9. The memory system of claim 7, wherein the processing circuitry is further configured to cause the memory system to:
determine that the second temperature metric is different from the temperature metric, wherein determining whether the temperature metric satisfies the threshold is based at least in part on determining that the second temperature metric is different from the temperature metric.

10. The memory system of claim 1, wherein the first protocol layer comprises a physical layer.

11. The memory system of claim 1, wherein the processing circuitry is further configured to cause the memory system to:
communicate, while operating according to the first power state and based at least in part on establishing the communications link, second data from the memory system using the communications link based at least in part on one or more first parameters associated with the first protocol layer.

12. A memory system, comprising:
one or more memory devices; and
processing circuitry coupled with the one or more memory devices and configured to cause the memory system to:
establish, while the memory system operates according to a first power state, a communications link between the memory system and a host system, the communications link based at least in part on a first resistor termination scheme associated with a first protocol layer;
determine whether a temperature metric of the memory system satisfies a threshold based on a power state of the memory system changing from the first power state to a second power state; and
communicate, while operating according to the second power state and based at least in part on the temperature metric satisfying the threshold, data from the memory system using the communications link based at least in part on a second resistor termination scheme associated with the first protocol layer, wherein the first resistor termination scheme is different than the second resistor termination scheme.

13. The memory system of claim 12, wherein the first power state comprises a disable state, a hibernate state, a sleep state, a stall state, or an unpowered state and the second power state is different from the first power state and comprises the disable state, the hibernate state, or the sleep state.

14. The memory system of claim 12, wherein the processing circuitry is further configured to cause the memory system to:
update a resistor termination scheme associated with the first protocol layer from the first resistor termination scheme to the second resistor termination scheme based at least in part on determining that the temperature metric satisfies the threshold.

15. The memory system of claim 12, wherein determining whether the temperature metric satisfies the threshold comprises the processing circuitry configured to cause the memory system to:
determine whether the temperature metric is above the threshold;
determine whether the temperature metric meets the threshold; or
determine whether the temperature metric is below the threshold.

16. The memory system of claim 12, wherein the processing circuitry is further configured to cause the memory system to:
determine, at a first time, a first operating temperature of the memory system, wherein the temperature metric comprises the first operating temperature;
determine, at a second time that is prior to the first time, a second operating temperature of the memory system, wherein a second temperature metric comprises the second operating temperature; and
compare the temperature metric to the second temperature metric based at least in part on determining the temperature metric.

17. The memory system of claim 16, wherein determining whether a difference between the temperature metric and the second temperature metric satisfies the threshold.

18. The memory system of claim 16, wherein the processing circuitry is further configured to cause the memory system to:
determine that the second temperature metric is different from the temperature metric, wherein determining whether the temperature metric satisfies the threshold is based at least in part on determining that the second temperature metric is different from the temperature metric.

19. The memory system of claim 12, wherein the first protocol layer comprises a physical layer.

20. The memory system of claim 12, wherein the processing circuitry is further configured to cause the memory system to:
communicate, while operating according to the first power state and based at least in part on establishing the communications link, second data from the memory system using the communications link based at least in part on the first resistor termination scheme associated with the first protocol layer.

21. A memory system, comprising:
a controller configured to cause the memory system to:
establish, while the memory system operates according to a first power state, a communications link between the memory system and a host system, the communications link based at least in part on one or more first parameters associated with a first protocol layer;
determine whether a temperature metric of the memory system satisfies a threshold based on a power state of the memory system changing from the first power state to a second power state; and
communicate, while operating according to the second power state and based at least in part on the temperature metric satisfying the threshold, data from the memory system using the communications link based at least in part on one or more second parameters associated with the first protocol layer, wherein the one or more second parameters are different from the one or more first parameters.
